(19) United States
(12) Patent Application Publication
(10) Pub. No.: US 2006/0253367 A1
(43) Pub. Date: Nov. 9, 2006

(54) Method of creating and trading derivative investment products based on a volume weighted average price of an underlying asset

(75) Inventors: Dennis M. O'Callahan, Evanston, IL (US); Catherine T. Shalen, Chicago, IL (US)

Correspondence Address: BRINKS HOFER GILSON & LIONE, P.O. BOX 10395, CHICAGO, IL, 60610, US

(73) Assignee: Chicago Board Options Exchange

(21) Appl. No.: 11/122,509

(22) Filed: May 4, 2005

(51) Int. Cl. G06Q 40/00

(52) U.S. Cl. 705/37

(57) ABSTRACT

A method of creating and trading derivative contracts based on a volume weighted average price (“VWAP”) of an underlying asset is disclosed. Typically, an underlying asset is chosen to be a base of a VWAP derivative and a processor calculates a VWAP reflecting an average trading price of an underlying asset during a calculation period that is weighted according to the proportion of a total volume of underlying assets traded at each traded price. A trading facility display device coupled to a trading platform then displays VWAP derivatives and the trading facility transmits VWAP derivative quotes from liquidity providers over at least one dissemination network.

### FIELD OF THE INVENTION

The present invention relates to derivative investment markets. More specifically, this invention relates to aspects of actively disseminating and trading derivatives.

### BACKGROUND

A derivative is a financial security whose value is derived in part from a value or characteristic of another security, known as an underlying asset. Two exemplary, well known derivatives are options and futures.

An option is a contract giving a holder of the option a right, but not an obligation, to buy or sell an underlying asset at a specific price on or before a certain date. Generally, a party who purchases an option is referred to as the holder of the option and a party who sells an option is referred to as the writer of the option.

There are generally two types of options: call options and put options. A holder of a call option receives a right to purchase an underlying asset at a specific price, known as the “strike price,” such that if the holder exercises the call option, the writer is obligated to deliver the underlying asset to the holder at the strike price. Alternatively, the holder of a put option receives a right to sell an underlying asset at a specific price, referred to as the strike price, such that if the holder exercises the put option, the writer is obligated to purchase the underlying asset at the agreed upon strike price. Thus, the settlement process for an option involves the transfer of funds from the purchaser of the underlying asset to the seller, and the transfer of the underlying asset from the seller of the underlying asset to the purchaser. This type of settlement may be referred to as “in kind” settlement. However, an underlying asset of an option does not need to be tangible, transferable property.

Options may also be based on more abstract market indicators, such as stock indices, interest rates, futures contracts and other derivatives. In these cases, in kind settlement may not be desired, or in kind settlement may not be possible because delivering the underlying asset is not possible. Therefore, cash settlement is employed. Using cash settlement, a holder of an index call option receives the right to “purchase” not the index itself, but rather a cash amount equal to the value of the index multiplied by a multiplier such as $100. Thus, if a holder of an index call option elects to exercise the option, the writer of the option is obligated to pay the holder the difference between the current value of the index and the strike price multiplied by the multiplier. However, the holder of the index will only realize a profit if the current value of the index is greater than the strike price. If the current value of the index is less than or equal to the strike price, the option is worthless due to the fact the holder would realize a loss.

Similar to options contracts, futures contracts may also be based on abstract market indicators. A future is a contract giving a buyer of the future a right to receive delivery of an underlying commodity or asset on a fixed date in the future. Accordingly, a seller of the future contract agrees to deliver the commodity or asset on the specified date for a given price. Typically, the seller will demand a premium over the prevailing market price at the time the contract is made in order to cover the cost of carrying the commodity or asset until the delivery date.

Although futures contracts generally confer an obligation to deliver an underlying asset on a specified delivery date, the actual underlying asset need not ever change hands. Instead, futures contracts may be settled in cash such that to settle a future, the difference between a market price and a contract price is paid by one investor to the other. Again, like options, cash settlement allows futures contracts to be created based on more abstract “assets” such as market indices. Rather than requiring the delivery of a market index (a concept that has no real meaning), or delivery of the individual components that make up the index, at a set price on a given date, index futures can be settled in cash. In this case, the difference between the contract price and the price of the underlying asset (i.e., current value of market index) is exchanged between the investors to settle the contract.

Derivatives such as options and futures may be traded over-the-counter, and/or on other trading facilities such as organized exchanges. In over-the-counter transactions the individual parties to a transaction are free to customize each transaction as they see fit. With trading facility traded derivatives, a clearing corporation stands between the holders and writers of derivatives. The clearing corporation matches buyers and sellers, and settles the trades. Thus, cash or the underlying assets are delivered, when necessary, to the clearing corporation and the clearing corporation disperses the assets as necessary as a consequence of the trades. Typically, such standard derivatives will be listed as different series expiring each month and representing a number of different incremental strike prices. The size of the increment in the strike price will be determined by the rules of the trading facility, and will typically be related to the value of the underlying asset.

While standard derivative contracts may be based on many different types of market indexes or statistical properties of underlying assets, currently standard derivative contracts do not allow investors to take positions in derivatives based on a volume weighted average price of an underlying asset.

### BRIEF SUMMARY

Accordingly, the present invention relates to a method of creating and trading derivative contracts based on a volume weighted average price (“VWAP”) of an underlying asset. VWAP derivatives provide inventors with a tool to track a difference between a price of an asset and the VWAP of the asset over a specificied period of time. In a first aspect, the invention relates to a method of creating derivatives based on the VWAP of an underlying asset. First, a processor calculates a VWAP of the underlying asset. The VWAP has a dynamic value reflecting an average trading price of the underlying asset during a calculation period that is weighted according to the proportion of the total volume of underlying assets traded at a trading price during the calculation period. A VWAP derivative based on the VWAP is displayed on a trading facility display device coupled to a trading platform and the trading facility transmits VWAP derivative quotes of a liquidity provider to at least one market participant.

In a second aspect, the invention relates to a method of creating derivatives based on a VWAP of an underlying asset. First, an underlying asset is chosen to be a base of a VWAP derivative. A VWAP of the underlying asset is chosen that has a dynamic value reflecting an average trading price of the underlying asset during a calculation period that is weighted according to the proportion of the total volume of underlying assets traded at each trading price. A trading facility display device then displays a VWAP derivative based on the VWAP.

In a third aspect, the invention relates to a system for creating and trading derivatives based on a VWAP of an underlying asset. Typically, the system comprises a VWAP module coupled with a communications network, a dissemination module coupled with the VWAP module and the communications network, and a trading module coupled with the dissemination module and the communications network.

Generally, the VWAP module calculates a cumulative VWAP and an implied VWAP settlement value of the underlying asset. The VWAP module passes the cumulative VWAP and indicative VWAP settlement value to the dissemination module, which transmits the cumulative VWAP and indicative VWAP settlement values to at least one market participant. The trading module receives buy or sell orders for the VWAP derivative, executes the buy or sell orders, and passes the result of the buy or sell orders to the dissemination module to transmit the result of the buy or sell order to at least one market participant.

### BRIEF DESCRIPTION OF THE DRAWINGS

FIG. 1 is a flow chart of a method of creating and trading a VWAP derivative;

FIG. 2 is a diagram showing a listing of VWAP futures contracts and VWAP option contracts on a trading facility;

FIG. 3 is a block diagram of a system for creating and trading VWAP derivatives; and

FIG. 4 is a table showing values for a VWAP derivative over a calculation period.

### DETAILED DESCRIPTION OF THE DRAWINGS

Volume weighed average price (“VWAP”) derivatives are financial instruments such as futures and option contracts that trade on trading facilities, such as exchanges, whose value is based on the VWAP of an underlying asset and on the current value of the underlying asset. A VWAP is an average traded price of an underlying asset over a calculation period that has been weighted according to the proportion of trades of the total volume of trading that occurs at each trading price. VWAP derivatives allow market participants to lock in a VWAP for an underlying asset plus or minus a spread that evolves continuously with intraday information regarding the underlying asset. The spread is the difference between a closing price of the underlying asset and the VWAP of the underlying asset.

Those skilled in the art will recognize that VWAP derivatives having features similar to those described herein and index values which reflect the VWAP of an underlying asset, but which are given labels other than VWAP derivatives, VWAP indexes, VWAP futures, or VWAP options will nonetheless fall within the scope of the present invention.

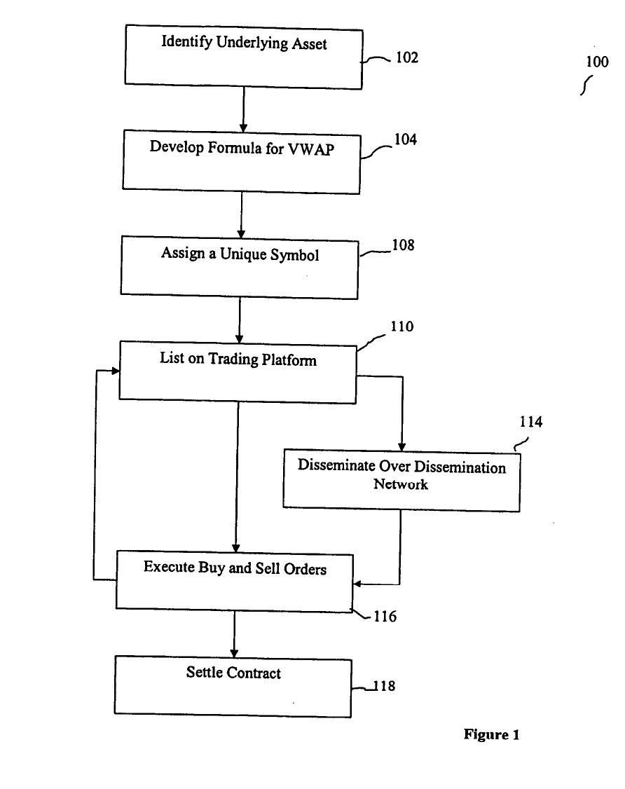

FIG. 1 is a flow chart of one embodiment of a method for creating and trading a VWAP derivative 100. A VWAP derivative is a financial instrument in which the VWAP of an underlying asset is calculated over a predefined time period, known as the calculation period. The VWAP may be calculated continuously or periodically at set time periods throughout the calculation period. Typically, the VWAP of an underlying asset is calculated using a standardized equation, which is a function of at least one trading price of an underlying asset and the number of underlying assets traded at each of the at least one trading price.

An investor is generally able to purchase a VWAP derivative before a calculation period begins, or an investor may trade into or out of a VWAP derivative during the calculation period. To facilitate the purchase and trading of VWAP derivatives, trading facilities such as exchanges like the Chicago Board Options Exchange (“CBOE”) Network or the CBOE Futures Network will calculate and disseminate a cumulative VWAP and an indicative VWAP settlement value for a VWAP derivative. Cumulative VWAP and indicative VWAP settlement values provide tools for investors to determine when to trade into and out of a VWAP derivative.

The method for creating and trading a VWAP derivative begins at step 102 by identifying an underlying asset or a set of underlying assets for the VWAP derivative. Typically, an underlying asset or set of assets is selected based on trading volume of a prospective underlying asset, the general level of interest of market participants in a prospective underlying asset, or for any other reason desired by a trading facility. The underlying assets for the VWAP derivatives may be equity indexes or securities; fixed income indexes or securities; foreign currency exchange rates; interest rates; commodity indexes; commodity or structured products traded on a trading facility or in the over-the-counter (“OTC”) market; or any other type of underlying asset which trades in volume from day to day.

Once the underlying asset or assets have been selected at 102, a formula is developed at 104 for generating a VWAP of the underlying asset or assets over the defined calculation period. In one embodiment, VWAP is calculated using a formula that weights a trading price proportionally to the number of underlying assets traded at the corresponding trading price in relation to the total number of underlying assets traded. Typically, VWAP is calculated according to the formula:

$$VWAP = \frac{{\sum }_{i = 1}^{T} ( {N}_{i} * {P}_{i} )}{{\sum }_{i = 1}^{T} {N}_{i}} ,$$

wherein Pᵢ is a trading price of the underlying asset during the calculation period, Nᵢ is the number of underlying assets traded at the corresponding trading price (Pᵢ), and T is the number of trading prices at which the underlying asset was traded during the calculation period.

Once the underlying asset or assets is chosen at 102 and the formula for generating the VWAP is determined at 104, the VWAP derivative based on the chosen underlying asset or assets is assigned a unique symbol at 108 and listed on a trading platform at 110. Generally, the VWAP derivative may be assigned any unique symbol that serves as a standard identifier for the type of standardized VWAP derivative.

Generally, a VWAP derivative may be listed on an electronic platform, an open outcry platform, a hybrid environment that combines the electronic platform and open outcry platform, or any other type of platform known in the art. One example of a hybrid exchange environment is disclosed in U.S. patent application Ser. No. 10/423,201, filed Apr. 24, 2003, the entirety of which is herein incorporated by reference. Additionally, a trading facility such as an exchange may transmit VWAP derivative quotes of liquidity providers over dissemination networks 114 to other market participants. Liquidity providers may include Designated Primary Market Makers (“DPM”), market makers, locals, specialists, trading privilege holders, registered traders, members, or any other entity that may provide a trading facility with a quote for a VWAP derivative. Dissemination Networks may include networks such as the Options Price Reporting Authority (“OPRA”), the CBOE Futures Network, an Internet website, or email alerts via email communication networks. Market participants may include liquidity providers, brokerage firms, normal investors, or any other entity that subscribes to a dissemination network.

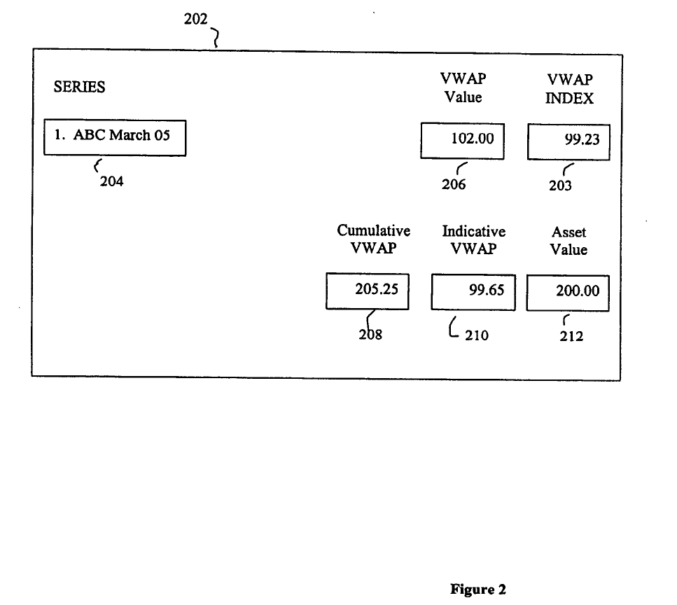

As seen in FIG. 2, VWAP derivatives are listed on a trading platform by displaying the VWAP derivative on a trading facility display device 202 coupled with the trading platform. In one embodiment, the VWAP derivative may be listed in terms of a VWAP index 203 comprising a constant plus the difference between an expected value of the underlying asset at the end of the calculation period and the expected value of the VWAP of the underlying asset at the end of the calculation period. The expected value of the underlying asset and the expected value of the VWAP of the underlying asset at the end of the calculation period are market determined such that the expected value are the best estimates of the market based on the information available at the time. Accordingly, the VWAP index may be calculated using the formula:
VWAP Index=100−(P_{V}−P_{VWAP}),
wherein 100 is a constant, P_{V} is the expected value of the underlying asset at the end of the calculation period and P_{VWAP} is the expected value of the VWAP of the underlying asset at the end of the calculation period.

In FIG. 2, a VWAP derivative 204 is listed at a value of 102.00 (206). A value of 102 is calculated by adding a constant (100.00) to a difference between an expected value of the underlying asset (308.50) and an expected value of the VWAP of the underlying asset (306.50).

In addition to listing VWAP derivatives in terms of a VWAP index 203, a VWAP derivative may also be listed in terms of a decimal, fractions, or any other numerical representation of a VWAP at the end of a calculation period. Further, scaling factors for the VWAP derivatives may be determined on a contract-by-contract basis to control the size, and therefore the price of a VWAP derivative.

Over the course of the calculation period, in addition to listing the VWAP derivatives in terms of VWAP indexes 203, the trading facility may also continually, or periodically, display and disseminate a cumulative VWAP value 208 and an indicative VWAP settlement value 210 to facilitate trading within the VWAP derivative 204. Cumulative VWAP 208 is a calculation of the VWAP for the underlying asset up to a current date in the calculation period. An indicative VWAP settlement value 210 is equal to a difference between the cumulative VWAP 208 and the current value 212 of the underlying asset. Referring to FIG. 1, the cumulative VWAP and indicative VWAP settlement value provide investors a tool for determining when to trade into and out of VWAP derivatives at 116.

At expiration of the calculation period for a VWAP derivative, the trading facility will settle 118 the VWAP derivative based on the indicative VWAP settlement value. At settlement 118, the indicative VWAP settlement value will reflect the cumulative VWAP of the underlying asset minus the closing price of the underlying asset that is calculated by the trading facility or an independent liquidity provider. In one embodiment, settlement of the VWAP derivative may be based on a cash difference between the VWAP at the end of the calculation period and the closing price of the underlying asset at the end of the calculation period.

In another embodiment, the VWAP derivative may be structured as a VWAP futures contract to require delivery of the underlying asset. In a VWAP futures contract, the purchaser of the VWAP futures contract receives a right to receive delivery of the underlying asset at the end of the calculation period and the seller of the VWAP futures contract agrees to deliver the underlying asset at the end of the calculation period for the VWAP. Therefore, at the end of the calculation period, if the VWAP of the underlying asset is below the current price of the underlying asset, the buyer of the VWAP futures contract will make a profit due to the fact the buyer purchases the underlying asset at a price less than currently available in the open market. However, at the end of the calculation period, if the VWAP of the underlying asset is the same or more than the current price of the underlying asset in the open market, the buyer of the VWAP future will realize a loss due to the fact the buyer must purchase the underlying asset at a price higher than its value on the open market.

In yet another embodiment, the VWAP derivative may be structured as a VWAP option contract. In a VWAP call option contract, the holder of the option receives a right to purchase the underlying asset at a strike price of a specified cumulative VWAP and the writer of the option agrees to sell the underlying asset to the holder at the strike price. Alternatively, in a VWAP put option contract, the holder of the option receives a right to sell the underlying asset at a strike price of a specified cumulative VWAP to the writer of the VWAP put option contract.

VWAP option contacts may be structured so that the holder of the option may exercise the option at any time during the calculation period or be structured so that the holder of the option may exercise the option only at the end of the calculation period. Additionally, VWAP option contracts may be structured so that the holder of the option may exercise their option “market on open” or “market on close.” An option is structured to be “market on open” when an option may be exercised at the VWAP at the opening of the market on which the underlying asset trades. An option is structured to be “market on close” when an option may be exercised at the VWAP at the closing of the market on which the underlying asset trades.

VWAP derivatives may additionally be structured as Flexible Exchange (“FLEX”) derivatives so that various terms of the VWAP derivative are variable. For example, the parties ot a VWAP FLEX derivative may set terms in the contrach such as strike price, expiration date, or exercise style in a manner different from the standard terms of regular VWAP derivatives.

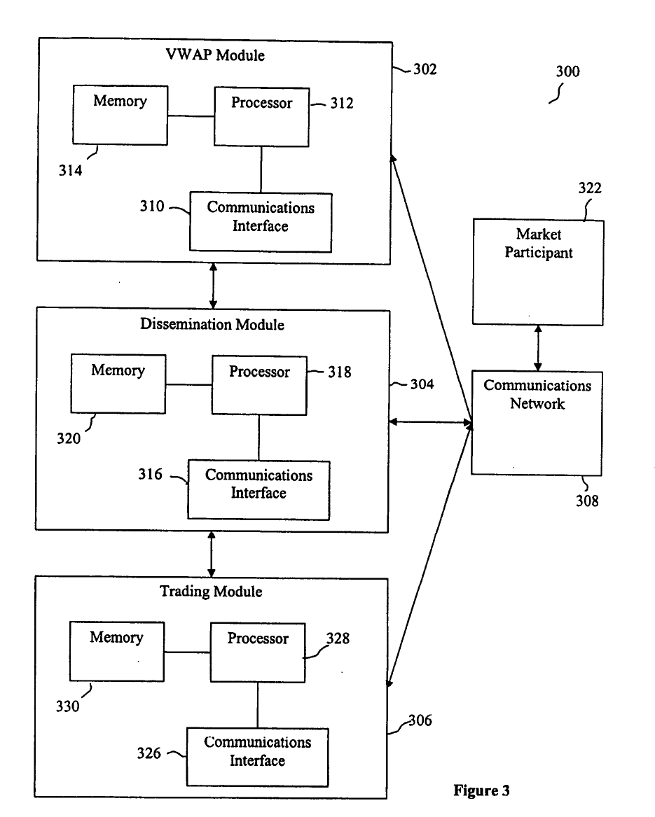

FIG. 3 is a block diagram of a system 300 for creating and trading VWAP derivatives. Generally, the system comprises a VWAP module 302, a dissemination module 304 coupled with the VWAP module 302, and a trading module 306 coupled with the dissemination module 304. Typically, each module 302, 304, 306 is also coupled to a communication network 308 coupled to market participants 322.

The VWAP module 302 comprises a communications interface 310, a processor 312 coupled with the communications interface 310, and a memory 314 coupled with the processor 312. Logic stored in the memory 314 is executed by the processor 312 such that that the VWAP module 302 may receive through the communications interface 310 information from an index provider such as a data vendor relating to at least one trading price at which an underlying asset is being traded and the volume of underlying assets being traded at each trading price; calculate a cumulative VWAP value and an indicative VWAP settlement value, as described above, for the underlying asset; and pass the calculated values to the dissemination module 304.

The dissemination module 304 comprises a communications interface 316, a processor 318 coupled with the communications interface 316, and a memory 320 coupled with the processor 318. Logic stored in the memory 320 is executed by the processor 318 such that the dissemination module 304 may receive the calculated values from the VWAP module 302 through the communications interface 316, and disseminate the calculated values over the communications network 308 to the market participants 322.

The trading module 306 comprises a communications interface 326, a processor 328 coupled with the communications interface 326, and a memory 330 coupled with the processor 328. Logic stored in the memory 330 is executed by the processor 328 such that the trading module 306 may receive buy or sell orders over the communications network 308 for a VWAP derivative, as described above, and pass the results of the buy or sell order for the VWAP derivative to the dissemination module 304 to be disseminated over the communications network 308 to the market participants 322.

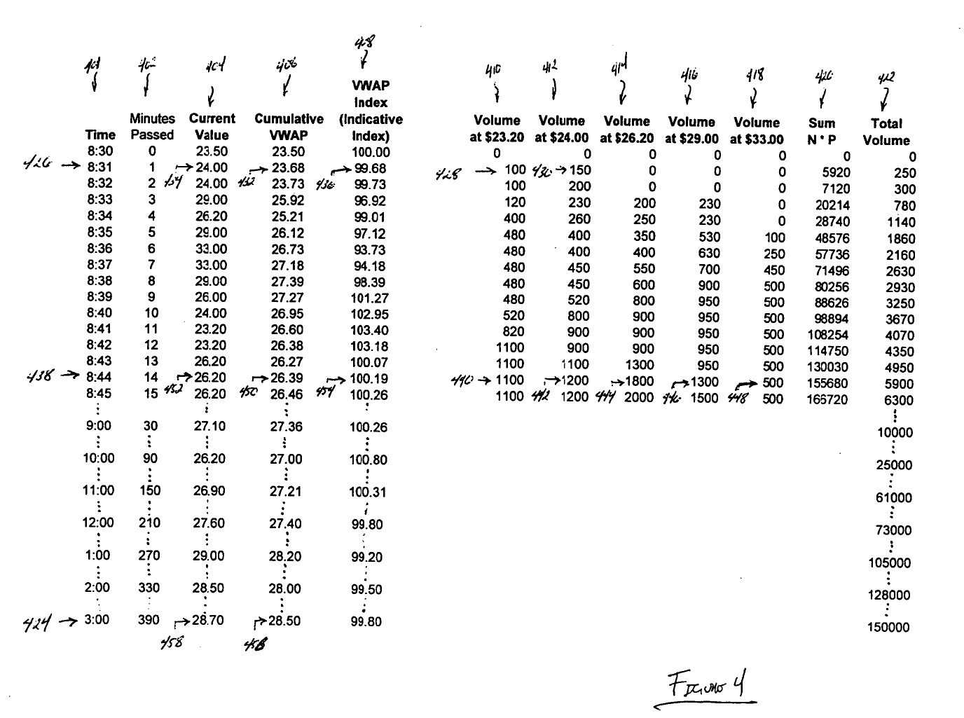

FIG. 4 is a table showing values for a VWAP derivative over a one-day calculation period. For purposes of illustration, values are only listed at the opening of trading, 15 minutes after the opening of trading and at the top of each hour during the one-day calculation period until the close of trading. The first column 401 shows the time of day during the one-day calculation period; column 402 shows the number of minutes that have passed in the one-day calculation period; column 404 shows the current value of the underlying asset; column 406 shows the cumulative VWAP; column 408 shows indicative VWAP settlement values; column 410 shows a volume of underlying assets traded at $23.20 in the first fifteen minutes of trading; column 412 shows a volume of underlying assets traded at $24.00 in the first fifteen minutes of trading; column 414 shows a volume of underlying assets traded at $26.20 in the first fifteen minutes of trading; column 416 shows a volume of underlying assets traded at $29.00 in the first fifteen minutes of trading; column 418 shows a volume of underlying assets traded at $33.00 in the first fifteen minutes of trading; column 420 shows a sum of the product of each price that the underlying asset has traded at and the number of underlying assets traded at that price; and column 422 shows a total number of underlying assets that have been traded during the calculation period.

In one example, the VWAP derivative is a VWAP futures contract. At the end of the calculation period of the VWAP futures contract, the purchaser of the VWAP futures contract agrees to purchase the underlying asset from the seller of the VWAP futures contract at the cumulative VWAP.

After one minutes of trading 426, 100 underlying assets are traded at $23.20 (428) and 150 underlying assets are traded at $24.00 (430). Using the number of underlying assets traded at each price, the VWAP of the underlying asset after one minute of trading 432 is calculated according to the formula described above as:

$$VWAP = \frac{{\sum }_{i = 1}^{T} ( {N}_{i} * {P}_{i} )}{{\sum }_{i = 1}^{T} {N}_{i}} = \frac{( 23.20 * 100 ) + ( 24.00 * 150 )}{100 + 1500} = 23.68 .$$

After calculating the VWAP of the underlying asset on the first day 432, a current value of the underlying asset 434 is used to calculated the indicative VWAP settlement value 436 as described above:

$$\begin{matrix}Indicative VWAP = 100 - ( Current . Value - Cum . VWAP ) \\ = 100 - ( 24.00 - 23.68 ) \\ = 100 - ( .32 ) \\ = 99.68\end{matrix}$$

This process is repeated throughout the one-day calculation period. For example, after 14 minutes of trading 438, 1100 underlying assets have been traded during the calculation period at $23.20 (440), 1200 underlying assets have been traded during the calculation period at $24.00 (442), 1800 underlying assets have been traded during the calculation period at $26.20 (444), 1300 underlying assets have been traded during the calculation period at $29.00 (446), and 500 underlying assets have been traded during the calculation period at $33.00 (448). Using the number of underlying assets traded at each price, the VWAP of the underlying asset after fourteen minutes of trading 450 is calculated according to the formula described above as:

$$VWAP = \frac{\begin{matrix}1100 * 23.20 + 1200 * 24.00 + 1800 * \\ 26.20 + 1300 * 29.00 + 500 * 33.00\end{matrix}}{1100 + 1200 + 1800 + 1300 + 500}$$

$$VWAP = \frac{155680}{5900} = 26.39$$

After calculating the VWAP of the underlying asset after fourteen minutes 450, a current value of the underlying asset 452 is used to calculated the indicative VWAP settlement value 454 as described above to be:

$$\begin{matrix}Indicative VWAP = 100 - ( Current . Value - Cum . VWAP ) \\ = 100 - ( 26.20 - 26.39 ) \\ = 100 - ( - .19 ) \\ = 100.19\end{matrix}$$

As seen in FIG. 4, at the end of the one-day calculation period 424, the underlying asset has a calculated cumulative VWAP of 28.5. Therefore, due to the fact the current value of the underlying asset (458) at the end of the one-day calculation period is more than the VWAP, the purchaser of the underlying asset receives a profit when the future is exercised. However if at the end of the calculation period the VWAP is more than the current value of the underlying asset, the purchaser of the VWAP futures contract will realize a loss.

In one embodiment, the VWAP futures contract may be structured so that the underlying asset is actually delivered to the purchaser of the VWAP futures contract. In another embodiment, the VWAP futures contract may be structured so that the cash difference between the VWAP and the current price of the underlying asset is delivered to the purchaser of the VWAP futures contract.

Alternatively, the VWAP derivative may be a VWAP option contract having a strike price based on the cumulative VWAP. In one example, a VWAP call option contract may have a strike price of 26.50 and be exercised at any time during the calculation period. Therefore, a holder of the VWAP call option contract could only exercise their option to make a profit during the calculation period when the VWAP is calculated to be above 26.50 such as after 6-11, 30, 150, 210, 270, 330, and 390 minutes of trading. At all other times shown times during the calculation period, if the holder of the VWAP call option exercised their option it would result in a loss.

Similarly, in another example, a VWAP call option contract may have a strike price of 26.50 and only be exercised at the end of the one-day calculation period. Therefore, due to the fact the VWAP is calculated to be above 26.5 at the end of the one-day calculation period 456, the holder of the VWAP call option may exercise their option for a profit. However, if the VWAP was calculated to be at or below 26.50 at the end of the one-day calculation period 456, the holder of the VWAP call option may not exercise their option for a profit.

In yet another example, a VWAP put option contract may have a strike price of 26.50 and be exercised at any time during the one-day calculation period. Therefore, a holder of the VWAP put option contract could only exercise their option to make a profit during the calculation period when the VWAP is calculated to be below 26.50 such as after 1-5, 12-15, and 90 minutes of trading. At all other shown times during the calculation period, if the holder of the VWAP put option exercised their option it would result in a loss.

Similarly, in another example, a VWAP put option contract may have a strike price of 26.50 and only be exercised at the end of the one-day calculation period. Therefore, due to the fact the VWAP is calculated to be above 26.50 at the end of the calculation period 456, the holder of the VWAP may not exercise their option for a profit. However, if the VWAP was calculated to be below 26.50 at the end of the calculation period 456, the holder of the VWAP put option can exercise their option for a profit.

According to another aspect of the present invention, chooser options may be created based on VWAP options. A chooser option is an option wherein the purchaser of the option buys a call or a put option at some time in the future. The call and the put option will typically share the same expiration date and the same strike price (value), although, split chooser options may be crafted wherein the call and the put options have different expirations and/or different strikes.

Chooser options are advantageous in situations in which investors believe that the price of the underlying asset is for a significant move, but the redirection of the move is in doubt. For example, some event, such as the approval (disapproval) of a new product, a new earnings report, or the like, may be anticipated such that positive news is likely cause the share price to rise, and negative news will cause the share price to fall. The ability to choose whether an option will be a put or a call having knowledge of the outcome of such an event is a distinct advantage to an investor.

The purchase of a chooser option is akin to purchasing both a put and a call option on the same underlying asset. Typically the chooser option is priced accordingly. In the present case, purchasing a VWAP chooser option amounts to buying both a put and a call option based on the VWAP of an underlying asset. Chooser options may be traded on an exchange just like other VWAP derivative. The only accommodations necessary for adapting an exchange for trading chooser options is that a final date for making the choice between a call option and a put option must be established and maintained. Also, post trade processing on the exchange's systems must be updated to implement and track the choice of the call or a put once the choice has been made. One option for processing the chosen leg of a chooser option is to convert the chooser option into a standard option contract according to the standard series for the same underlying asset and having the same strike price as the chosen leg of the chooser option.

It is therefore intended that the foregoing detailed description be regarded as illustrative rather than limiting, and that it be understood that it is the following claims, including all equivalents, that are intended to define the spirit and scope of this invention.

1. A method of creating derivatives based on a volume weighted average price (“VWAP”) of an underlying asset, comprising:
receiving trading price information for the underlying asset from at least one index provider;
calculating a VWAP of the underlying asset on a processor, the VWAP having a dynamic value reflecting an average trading price of the underlying asset during a calculation period that is weighted according to the proportion of a total volume of underlying assets traded at each trading price;
displaying VWAP derivatives relating to the VWAP on a trading facility display device coupled to a trading platform;
receiving at least one VWAP derivative quote from a liquidity provider; and
transmitting VWAP derivative quotes of at least one liquidity provider from the trading facility to at least one market participant.

2. The method of claim 1, wherein the underlying asset is selected from the group consisting of: equity indexes or securities; fixed income indexes or securities; foreign currency exchange rates; interest rates; commodity indexes; and commodity or structured products traded on a trading facility or over-the-counter market.

3. The method of claim 1, wherein calculating the VWAP comprises:
calculating the VWAP according to the formula:
$$VWAP = \frac{{\sum }_{i = 1}^{T} ( {N}_{i} * {P}_{i} )}{{\sum }_{i = 1}^{T} {N}_{i}} ,$$
wherein Pᵢ is a trading price of the underlying asset during the calculation period, Nᵢ is a volume of underlying assets traded at the corresponding trading price (Pᵢ), and T is a number of trading prices at which the underlying asset was traded during the calculation period.

4. The method of claim 1, wherein the trading facility is an exchange.

5. The method of claim 1, wherein the liquidity provider is selected from the group consisting of: Designated Primary Market Makers (“DPM”), market makers, locals, specialists, trading privilege holders, and, members.

6. The method of claim 1, wherein the market participant is selected from the group consisting of: a liquidity provider, a brokerage firm, and a normal investor.

7. The method of claim 1, further comprising:
executing trades for the VWAP derivatives by matching bids and offers to buy and sell positions in the VWAP derivatives.

8. The method of claim 1, wherein at least one of the VWAP derivatives is a VWAP option contract.

9. The method of claim 1, wherein at least one of the VWAP derivatives is a VWAP futures contract.

10. The method of claim 1, further comprising:
calculating a cumulative VWAP on a processor, wherein the cumulative VWAP is the VWAP of the underlying asset during the calculation period up to a current date;
displaying the cumulative VWAP on the trading facility display device; and
transmitting the cumulative VWAP from the trading facility to at least one market participant.

11. The method of claim 10, further comprising:
calculating an indicative VWAP settlement value on a processor, wherein the indicative VWAP settlement value is a difference between the cumulative VWAP value and a current value of the underlying asset:
displaying the indicative VWAP settlement value on the trading facility display device; and
transmitting the indicative VWAP settlement value from the trading facility to at least one market participant.

12. The method of claim 11, further comprising transmitting the cumulative VWAP and the indicative VWAP settlement value from the trading facility over at least one dissemination network.

13. The method of claim 11, wherein the cumulative VWAP and the indicative VWAP settlement value are calculated continuously.

14. The method of claim 1, wherein the trading platform is an open outcry platform.

15. The method of claim 1, wherein the trading platform is an electronic platform.

16. The method of claim 1, wherein the trading platform is a hybrid of an open outcry platform and an electronic platform.

17. The method of claim 1, further comprising:
transmitting the VWAP derivative quotes of the liquidity provider over at least one dissemination network.

18. A method of creating derivatives based on a volume weighted average price (“VWAP”) of at least one underlying asset, comprising:
choosing at least one underlying asset to be a base of a VWAP derivative;
receiving trading price information for the at least one underlying asset from at least one index provider;
calculating a VWAP of the at least one underlying asset, the VWAP having a dynamic value which reflects an average trading price of the at least one underlying asset during a calculation period that is weighted according to the proportion of a total volume of underlying assets traded at each trading price; and
displaying VWAP derivatives based on the VWAP on a trading facility display device coupled to a trading platform.

19. The method of claim 18, further comprising:
transmitting quotes for the VWAP derivatives of at least one liquidity provider over a dissemination network to at least one market participant.

20. The method of claim 19, wherein the liquidity provider is selected from the group consisting of: Designated Primary Market Makers (“DPM”), market makers, locals, specialists, trading privilege holders, and members.

21. The method of claim 19, wherein the market participant is selected from the group consisting of: a liquidity provider, a brokerage firm, and a normal investor.

22. The method of claim 18, wherein the VWAP is calculated continuously.

23. The method of claim 18, wherein the at least one underlying asset is selected from the group consisting of: equity indexes or securities; fixed income indexes or securities; foreign currency exchange rates; interest rates; commodity indexes; and commodity or structured products traded on a trading facility or over-the-counter market.

24. The method of claim 18, wherein calculating a VWAP comprises:
calculating the index according to the formula:
$$VWAP = \frac{{\sum }_{i = 1}^{T} ( {N}_{i} * {P}_{i} )}{{\sum }_{i = 1}^{T} {N}_{i}} ,$$
wherein Pᵢ is a trading price of the at least one underlying asset during the calculation period, Nᵢ is a volume of underlying assets traded at the corresponding trading price (Pᵢ), and T is a number of trading prices at which the at least one underlying asset was traded during the calculation period.

25. The method of claim 18 wherein at least one of the VWAP derivatives is a VWAP futures contract.

26. The method of claim 18 wherein at least one of the VWAP derivatives is a VWAP option contract.

27. The method of claim 18, wherein the trading facility is an exchange.

28. The method of claim 18, further comprising:
calculating a cumulative VWAP, wherein the cumulative VWAP is the VWAP of the at least one underlying asset during the calculation period up to a current date;
calculating an indicative VWAP settlement value, wherein the indicative VWAP settlement value is a difference between the cumulative VWAP value and a current trading price of the at least one underlying asset;
displaying the cumulative VWAP and the indicative VWAP settlement value on the trading facility display device; and
transmitting the cumulative VWAP and the indicative VWAP settlement value from the trading facility to at least one market participant.

29. A system for creating and trading derivatives based on a volume weighted average price (“VWAP”) of an underlying asset, comprising:
a VWAP module comprising a first processor, a first memory coupled with the first processor, and a first communications interface coupled with a communications network, the first processor, and the first memory;
a dissemination module coupled with the VWAP module, the dissemination module comprising a second processor, a second memory coupled with the second processor, and a second communications interface coupled with the communications network, the second processor, and the second memory;
a first set of logic, stored in the first memory and executable by the first processor to receive through the communications network, trading prices for an underlying asset of a VWAP derivative and a volume of underlying assets traded at the trading prices; calculate a cumulative VWAP and an indicative VWAP settlement value; and pass the cumulative VWAP and indicative VWAP settlement value to the dissemination module; and
a second set of logic, stored in the second memory and executable by the second processor to receive the cumulative VWAP and indicative VWAP settlement value for the underlying asset from the VWAP module; and disseminate the calculated values through the second communications interface to at least one market participant.

30. The system of claim 29, further comprising:
a trading module coupled with the dissemination module, the trading module comprising a third processor, a third memory coupled with the third processor, and a third communications interface coupled with the communications network, the third processor, and the third memory; and
a third set of logic, stored in the third memory and executable by the third processor, to receive at least one buy or sell order for the VWAP derivative; execute the buy or sell order; and pass a result of the buy or sell order to the dissemination module; and
a fourth set of logic, stored in the second memory and executable by the second processor to receive the result of the buy or sell order from the trading module and disseminate the result of the buy or sell order through the second communications network to the at least one market participant.

31. A system for creating and trading derivatives based on a volume weighted average price (“VWAP”) of an underlying asset, comprising:
a VWAP module coupled with a communications network for receiving trading prices for an underlying asset of a VWAP derivative and a volume of underlying assets traded at the trading prices, and calculating a cumulative VWAP and an indicative VWAP settlement value of the underlying asset;
a dissemination module coupled with the VWAP module and the communications network for receiving the cumulative VWAP and indicative VWAP settlement value of the underlying asset from the VWAP module, and disseminating the values of the cumulative VWAP and indicative VWAP settlement value of the underlying asset to at least one market participant; and
a trading module coupled with the dissemination module and the communications network for receiving at least one buy or sell order for the VWAP derivative, and executing the at least one buy or sell order.
